(19) United States
(12) Patent Application Publication
(10) Pub. No.: US 2025/0249708 A1
(43) Pub. Date: Aug. 7, 2025

(54) IRON HOOKED BALANCE WEIGHT AND PRODUCTION PROCESS THEREOF

(71) Applicant: NINGBO SIMING AUTOMOTIVE Co.,Ltd., Ningbo (CN)

(72) Inventors: Lihong WANG, Ningbo (CN); ERMALD MUCA, Ningbo (CN); Xinfeng WANG, Ningbo (CN)

(73) Assignee: NINGBO SIMING AUTOMOTIVE Co.,Ltd., Ningbo (CN)

(21) Appl. No.: 18/824,968

(22) Filed: Sep. 5, 2024

(30) Foreign Application Priority Data
Feb. 6, 2024 (CN) 202410169158.5

(51) Int. Cl. B60C 19/00

(52) U.S. Cl. CPC B60C 19/003

(57) ABSTRACT

An iron hooked balance weight includes a balance weight body and a hook. A hook positioning cavity is machined in a center of a back surface of the balance weight body, and two first riveting holes are machined in the hook positioning cavity. The hook includes a riveting part and a hook body part. The hook body part is provided with a cambered window, and an anti-dropping barb is arranged in the cambered window. Two second riveting holes are formed in the riveting part, and the hook and the balance weight body are riveted through a riveting member. The hook body part fits with a top surface of the balance weight body to form a hooking cavity, and a hooking introduction port of the hooking cavity is formed between a front end of the hook body part and a front end surface of the balance weight body.

### CROSS REFERENCE TO THE RELATED APPLICATIONS

This application is based upon and claims priority to Chinese Patent Application No. 202410169158.5, filed on Feb. 6, 2024, the entire contents of which are incorporated herein by reference.

### TECHNICAL FIELD

The present disclosure relates to the technical field of automobile parts, in particular, to a balance weight applied to automobile wheels, specifically, to an iron hooked balance weight and a production process thereof.

### BACKGROUND

A hooked balance weight is used for adding an appropriate counterweight to a part of a wheel tire assembly that has low mass, such that wheels can maintain dynamic balance during rotation at a high speed. The hooked balance weight in the prior art is mainly composed of zinc and lead, but the zinc material is high in cost, which affects production costs. Lead is not environmentally friendly, does not meet restriction of hazardous substances (RoHS) standards, and has been banned in European and American countries.

### SUMMARY

Against the technical problem to be solved by the present disclosure, in view of the present situation of the prior art mentioned above, the present disclosure provides an iron hooked balance weight and a production process thereof. The iron hooked balance weight is simple in structure, low in production cost, economical, environmentally friendly and more resistant to corrosion.

The technical solutions adopted by the present disclosure to solve the above technical problems are as follows:

An iron hooked balance weight includes a balance weight body and a hook that are made of an iron material, where a hook positioning cavity is machined in a center of a back surface of the balance weight body, and two first riveting holes are machined in the hook positioning cavity; the hook includes a riveting part adapted to the hook positioning cavity and a hook body part bent in a cambered shape forward and downward; the hook body part is provided with a cambered window that facilitates disassemble, and an anti-dropping barb is arranged in the cambered window; two second riveting holes are formed in the riveting part, and the hook and the balance weight body are riveted into a whole through a riveting member; the hook body part fits with a top surface of the balance weight body to form a hooking cavity having an anti-dropping function, and a hooking introduction port of the hooking cavity is formed between a front end of the hook body part and a front end surface of the balance weight body.

In order to optimize the above technical solutions, the following specific measures are further taken.

A depth of the hook positioning cavity is greater than a thickness of the hook.

Lead angle inclined surfaces that facilitate introduction during hooking are machined on two sides of the front end of the hook body part.

The balance weight body is in a shape of a cambered segment, and a curvature of the cambered segment is adapted to a curvature of an automobile hub.

An element symbol representing a material of the balance weight body is provided on the back surface of the balance weight body and located on a left side of the hook positioning cavity, and a digital symbol representing a number of counterweights of the balance weight body is provided on the back surface of the balance weight body and located on a right side of the hook positioning cavity.

A large arc surface is connected between the top surface and the front end surface of the balance weight body, and a small arc surface is connected between a bottom surface and the front end surface of the balance weight body.

An English letter for marking a product series is provided on the riveting part.

The element symbol, the digital symbol, and the English letter are all convex identifiers.

The top surface and the bottom surface of the balance weight body are inclined surfaces.

The present disclosure further provides a production process of an iron hooked balance weight. The production process includes the following steps:
manufacturing of a hook: selecting a 65 Mn spring steel plate, punching and forming a hook through a punching device, and performing heat treatment on the hook after the punching and forming, such that hardness of the hook reaches Rockwell hardness (HRC) 38-45;
manufacturing of a balance weight body: selecting Q235 ordinary carbon structural steel and subjecting the Q235 ordinary carbon structural steel to profile pre-drawing, profile annealing, profile fine drawing, profile bending and blanking, notch milling, deburring, and riveting point punching to manufacture the balance weight body;
riveting forming: riveting the manufactured hook and balance weight body into a whole through a riveting member by a riveting device to manufacture a pre-finished product;
electroplating: performing surface treatment on the pre-finished product by electroplating dacromet;
product inspection: sampling an electroplated product for salt spray test, where it is required that there is no red rust for 360 hours or more; and
packaging and warehousing: packaging and warehousing a qualified product to obtain the iron hooked balance weight.

Compared with the prior art, the iron hooked balance weight according to the present disclosure is made of the iron material, and includes the balance weight body and the hook, and the balance weight body and the hook are riveted into a whole through the riveting member. The hook body part of the hook fits with the top surface of the balance weight body to form the hooking cavity, and the hooking cavity has an effect of limiting a vertical moving distance of the hooked balance weight, such that the hooked balance weight can be disassembled only when inclined by a certain angle, and use safety of the iron hooked balance weight is ensured. An outer surface of the iron hooked balance weight is provided with an electroplating layer formed by electroplating the dacromet. The electroplated iron hooked balance weight has attractive appearance and high corrosion resistance. The iron hooked balance weight is simple in production process, low in manufacturing cost, and suitable for mass production.

### BRIEF DESCRIPTION OF THE DRAWINGS

FIG. 1 is a schematic sectional view of a structure according to the present disclosure;

FIG. 2 is a right view of FIG. 1;

FIG. 3 is a left view of FIG. 1;

FIG. 4 is a schematic structural diagram of a hook according to the present disclosure;

FIG. 5 is a side view of FIG. 4;

FIG. 6 is a rear view of FIG. 4;

FIG. 7 is a schematic structural diagram when a top surface and a bottom surface of a balance weight body are inclined surfaces according to the present disclosure;

FIG. 8 is a schematic diagram of a process of the present disclosure;

FIG. 9 is a schematic diagram showing mounting tangential force test according to the present disclosure; and

FIG. 10 is a schematic diagram showing mounting axial force test according to the present disclosure.

### DETAILED DESCRIPTION OF THE EMBODIMENTS

The embodiments of the present disclosure are further described in detail below with reference to the accompanying drawings.

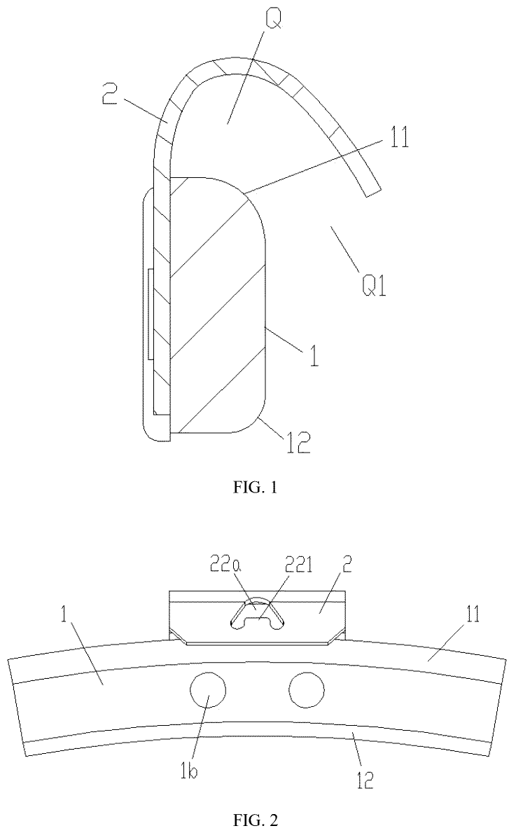

FIGS. 1 to 8 are schematic diagrams of structures and a process according to the present disclosure.

Reference signs: Hooking cavity Q, hooking introduction port Q1, balance weight body 1, hook positioning cavity 1a, first riveting hole 1b, large arc surface 11, small arc surface 12, hook 2, riveting part 21, second riveting hole 21a, hook body part 22, cambered window 22a, anti-dropping barb 221, lead angle inclined surface 222, element symbol 3, digital symbol 4, English letter 5, rim flange 6.

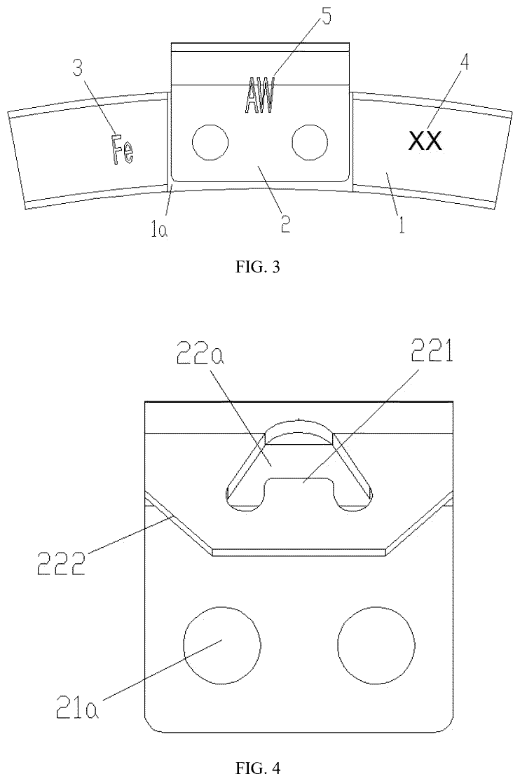

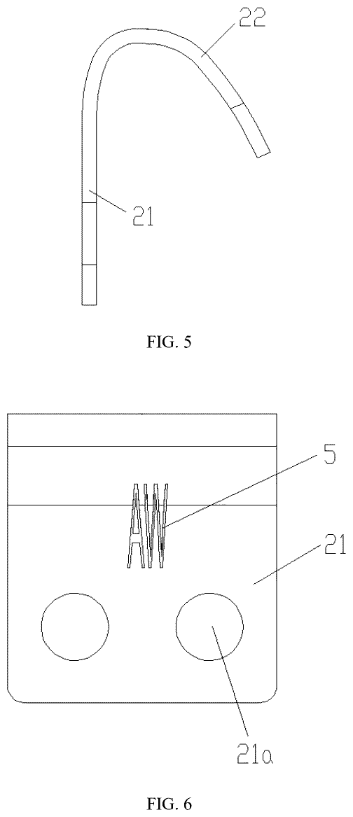

In the prior art, a conventional hooked balance weight is mainly composed of zinc and lead, and but the zinc material is high in cost, which affects production costs. The lead is not environmentally friendly and does not meet RoHS standards. Therefore, the present disclosure provides an iron hooked balance weight. As shown in FIGS. 1 to 7, the iron hooked balance weight includes balance weight body 1 and hook 2 that are made of an iron material. The balance weight body 1 is made of Q235 ordinary carbon structural steel, and the hook 2 is made of 65 Mn spring steel. As can be clearly seen from FIG. 3, hook positioning cavity 1a is machined in a central segment of a back surface of the balance weight body 1, and the hook positioning cavity 1a is a notched groove cavity with a depth of 1.5 millimeters to 2 millimeters. Two first riveting holes 1b are machined in the notched groove cavity through the thickness of the balance weight body 1. As can be seen from FIGS. 4 and 5, the hook 2 includes riveting part 21 and hook body part 22 that are integrally connected, and a dimension of the riveting part 21 is adapted to a dimension of the hook positioning cavity 1a, such that the riveting part can be exactly clamped therein. The hook body part 22 is connected to an upper end of the riveting part 21, bends forward in a cambered shape and then obliquely extends downward to form a hook part suitable for hooking. The hook body part 22 is provided with cambered window 22a. After the iron hooked balance weight is mounted on the automobile hub, the iron hooked balance weight can be very easily removed by using a tool through the cambered window 22a. Anti-dropping barb 221 is further arranged on the hook body part 22 and located in the cambered window 22a, and the anti-dropping barb 221 can clamp the hub after being mounted to avoid dropping off. Two second riveting holes 21a are formed in the riveting part 21, and the second riveting holes 21a coaxially correspond to the first riveting holes 1b, such that a riveting member (not shown in the figures) can be allowed to pass through. The riveting member may be any iron rivet in the prior art, and the hook 2 and the balance weight body 1 are riveted into a whole through the riveting member, such that the riveting structure is firmer. As shown in FIG. 1, the hook body part 22 fits with a top surface of the balance weight body 1 to form hooking cavity Q having an anti-dropping function. The hook body part 22 and the top surface of the balance weight body 1 define a distance between an upper part and a lower part of the hooking cavity Q, such that the iron hooked balance weight cannot drop off from a hooking part vertically upward, thus ensuring use safety of the iron hooked balance weight. Hooking introduction port Q1 of the hooking cavity Q is formed between a front end of the hook body part 22 and a front end surface of the balance weight body 1.

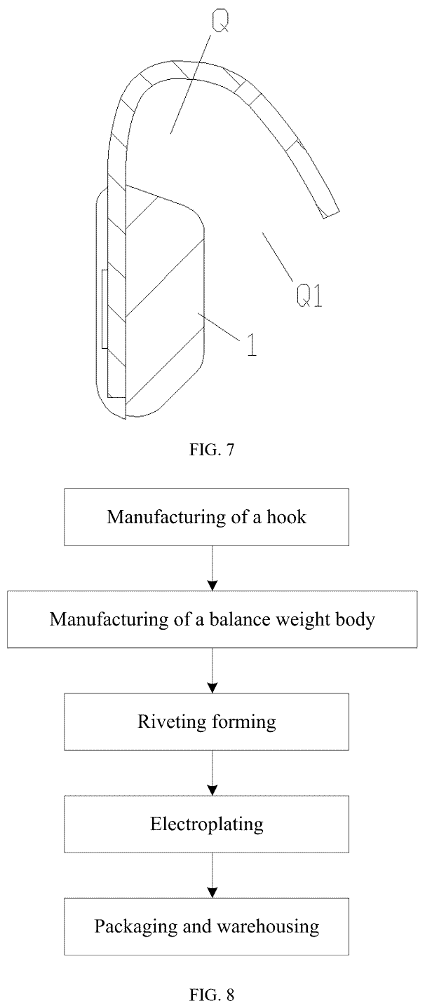

As can be seen from FIGS. 1 and 7 in the embodiment, according to the present disclosure, a depth of the hook positioning cavity 1a is greater than a thickness of the hook 2. Weights of the balance weight body 1 and the hook 2 add up to meet a product standard gram weight.

As shown in FIG. 4 in the embodiment, in order to facilitate hooking and mounting, lead angle inclined surfaces 222 that facilitate introduction during hooking are machined on two sides of the front end of the hook body part 22 according to the present disclosure.

As shown in FIGS. 2 and 3 in the embodiment, the balance weight body 1 according to the present disclosure is in a shape of a cambered segment, and a curvature of the cambered segment is adapted to a curvature of an automobile hub.

As shown in FIG. 3 in the embodiment, element symbol 3 representing a material of the balance weight body is provided on the back surface of the balance weight body 1 according to the present disclosure and located on a left side of the hook positioning cavity 1a, and digital symbol 4 representing a number of counterweights of the balance weight body is provided on the back surface of the balance weight body 1 and located on a right side of the hook positioning cavity 1a.

As shown in FIG. 1 in the embodiment, large arc surface 11 is connected between the top surface and the front end surface of the balance weight body 1 according to the present disclosure, and small arc surface 12 is connected between a bottom surface and the front end surface of the balance weight body 1.

The present disclosure further provides balance weight body 1 with another structure. As shown in FIG. 7, a top surface and a bottom surface of the balance weight body 1 with this structure are both inclined surfaces.

As shown in FIGS. 3 and 6 in the embodiment, an English letter 5 for marking a product series is provided on the riveting part 21.

In the embodiment, the element symbol 3, the digital symbol 4, and the English letter 5 according to the present disclosure are all convex identifiers. The identifier has a letter height of 4 millimeters and a width of 3 millimeters.

An outer surface of the iron hooked balance weight according to the present disclosure is provided with an electroplating layer formed by electroplating the dacromet. A dacromet electroplating process is more environmentally friendly and more resistant to corrosion.

The present disclosure further provides a production process of an iron hooked balance weight. The production process includes the following steps.

Manufacturing of a hook: A 65 Mn spring steel plate is selected, a hook 2 is punched and formed through a punching device, and heat treatment is performed on the hook 2 after the punching and forming, such that hardness of the hook reaches HRC 38-45.

Manufacturing of a balance weight body: Q235 ordinary carbon structural steel is selected and the Q235 ordinary carbon structural steel is sequentially subjected to profile pre-drawing, profile annealing, profile fine drawing, profile bending and blanking, notch milling, deburring, and riveting point punching to manufacture the balance weight body 1.

Riveting forming: The manufactured hook and balance weight body are riveted into a whole through a riveting member by a riveting device to manufacture a pre-finished product.

Electroplating: Surface treatment is performed on the pre-finished product by electroplating dacromet.

Product inspection: An electroplated product is sampled for salt spray test, where it is required that there is no red rust for 360 hours or more.

Packaging and warehousing: A qualified product is packaged and warehoused to obtain the iron hooked balance weight.

In the product inspection step of the present disclosure, the electroplated product is sampled for salt spray test, the balance weight is placed in a neutral salt spray test box (reference standard: GB/T 2423-17), and there is no red rust or spots on a surface of the product after 360 hours.

The product inspection further includes: balance weight mounting tangential force test and balance weight mounting axial force test.

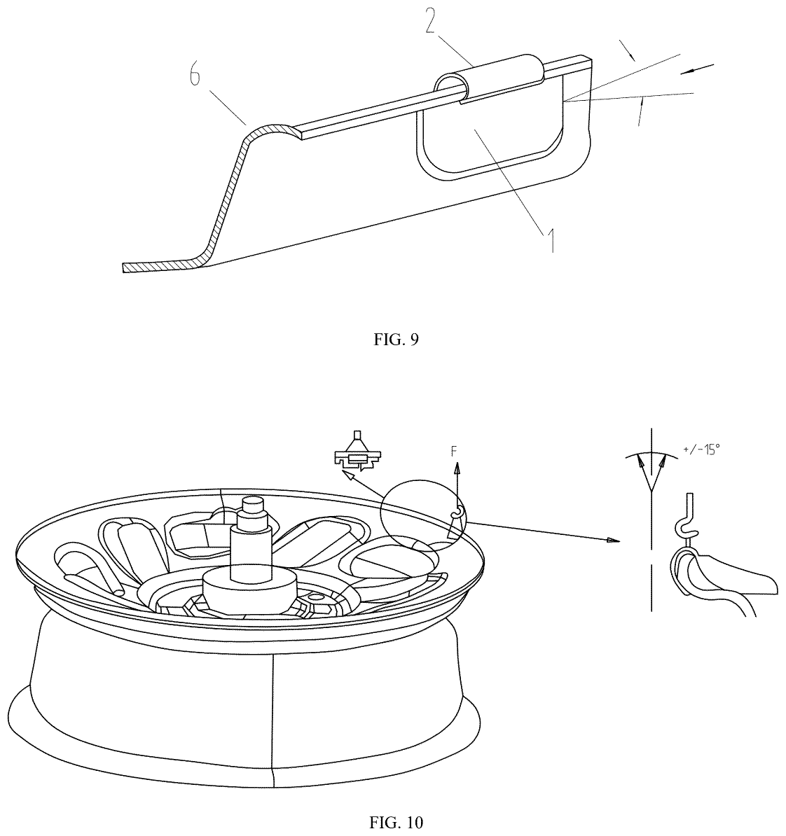

The balance weight mounting tangential force test is to mount the balance weight on a hub, and use a thrust meter to apply a thrust with a required value (a thrust angle and a level of the balance weight shall not exceed 15° C.) to a side edge of the balance weight body. The balance weight cannot be shifted. The test method is shown in FIG. 9.

The balance weight mounting axial force test is to mount the balance weight on the hub, and apply a pulling force with a required value (a direction of the pulling force is perpendicular to a hub shaft end, with an angle not exceeding 15° C.) to the shaft end. The balance weight cannot be shifted or drop. The test method is shown in FIG. 10.

The optimal embodiment of the present disclosure has been explained, and various changes or modifications made by those of ordinary skill in the art shall not depart from the scope of the present disclosure.

1. An iron hooked balance weight, comprising a balance weight body and a hook, wherein the balance weight body and the hook are made of an iron material; a hook positioning cavity is machined in a center of a back surface of the balance weight body, and two first riveting holes are machined in the hook positioning cavity; the hook comprises a riveting part adapted to the hook positioning cavity and a hook body part bent in a cambered shape forward and downward; the hook body part is provided with a cambered window, wherein the cambered window facilitates disassemble, and an anti-dropping barb is arranged in the cambered window; two second riveting holes are formed in the riveting part, and the hook and the balance weight body are riveted into a whole through a riveting member; the hook body part fits with a top surface of the balance weight body to form a hooking cavity having an anti-dropping function, and a hooking introduction port of the hooking cavity is formed between a front end of the hook body part and a front end surface of the balance weight body.

2. The iron hooked balance weight according to claim 1, wherein a depth of the hook positioning cavity is greater than a thickness of the hook.

3. The iron hooked balance weight according to claim 2, wherein lead angle inclined surfaces are machined on two sides of the front end of the hook body part and facilitate introduction during hooking.

4. The iron hooked balance weight according to claim 3, wherein the balance weight body is in a shape of a cambered segment, and a curvature of the cambered segment is adapted to a curvature of an automobile hub.

5. The iron hooked balance weight according to claim 4, wherein an element symbol representing a material of the balance weight body is provided on the back surface of the balance weight body and located on a left side of the hook positioning cavity, and a digital symbol representing a number of counterweights of the balance weight body is provided on the back surface of the balance weight body and located on a right side of the hook positioning cavity.

6. The iron hooked balance weight according to claim 5, wherein a large arc surface is connected between the top surface and the front end surface of the balance weight body, and a small arc surface is connected between a bottom surface and the front end surface of the balance weight body.

7. The iron hooked balance weight according to claim 6, wherein an English letter for marking a product series is provided on the riveting part.

8. The iron hooked balance weight according to claim 7, wherein the element symbol, the digital symbol, and the English letter are all convex identifiers.

9. The iron hooked balance weight according to claim 8, wherein the top surface and the bottom surface of the balance weight body are inclined surfaces.

10. A production process of the iron hooked balance weight according to claim 9, comprising the following steps:
manufacturing of the hook: selecting a 65 Mn spring steel plate, punching and forming the hook through a punching device, and performing heat treatment on the hook after the punching and forming, such that hardness of the hook reaches Rockwell hardness (HRC) 38-45;
manufacturing of the balance weight body: selecting Q235 ordinary carbon structural steel and subjecting the Q235 ordinary carbon structural steel to profile pre-drawing, profile annealing, profile fine drawing, profile bending and blanking, notch milling, deburring, and riveting point punching to manufacture the balance weight body;
riveting forming: riveting the hook and the balance weight body into the whole through the riveting member by a riveting device to manufacture a pre-finished product;
electroplating: performing surface treatment on the pre-finished product by electroplating dacromet;
product inspection: sampling an electroplated product for salt spray test, wherein it is required that there is no red rust for 360 hours or more; and
packaging and warehousing: packaging and warehousing a qualified product to obtain the iron hooked balance weight.
